(19) United States
(12) Patent Application Publication
(10) Pub. No.: US 2019/0390070 A1
(43) Pub. Date: Dec. 26, 2019

(54) PAINT PRIMER ADDITIVE AND USES THEREOF

(71) Applicant: Bye Bye Wifi, LLC, Atlanta, GA (US)

(72) Inventors: Avyesh V. Kapadia, Suwanee, GA (US); Narenprakash Jayagopi, Cumming, GA (US); Hitesh Krishna Muni Kamisetty, Cumming, GA (US); Shiva Pawar, Duluth, GA (US); Suhana Shirol, Roswell, GA (US); James A. Beach, Sandy Springs, GA (US)

(21) Appl. No.: 16/448,859

(22) Filed: Jun. 21, 2019

Related U.S. Application Data
(60) Provisional application No. 62/688,656, filed on Jun. 22, 2018.

(51) Int. Cl. C09D 7/61; C09D 5/00; C09D 5/32; C08K 3/013; C08K 3/04; C08K 3/22

(52) U.S. Cl. CPC C09D 7/61; C09D 5/002; C09D 5/32; C08K 2003/085; C08K 3/04; C08K 3/22; C08K 3/013

(57) ABSTRACT

Described herein are paint primer additives and paint primer formulations thereof. The paint primer formulations and paint primer additive described herein can be applied to surface or portion thereof. The paint primer additive and/or paint primer formulations described herein can be effective to block or reduce transmission of electromagnetic radiation through a surface.

### CROSS-REFERENCE TO RELATED APPLICATION

This application claims priority to U.S. Provisional Application entitled “PAINT PRIMER ADDITIVE AND USES THEREOF,” having Ser. No. 62/688,656, filed on Jun. 22, 2018, which is entirely incorporated herein by reference.

### BACKGROUND

It can be desirable to block one or more electromagnetic wavelengths. While devices exist that can block electromagnetic wavelengths, some are bulky devices or are otherwise impractical and hard to adapt to large and/or complex surfaces. As such, there exists a need for the improvements to address the aforementioned deficiencies.

### SUMMARY

Described herein are embodiments of primer paint additives (also referred to herein as primer additives, paint additives, or additives). In embodiments according to the present disclosure, primer paint additives as described herein can comprise: an amount of graphite; an amount of aluminum oxide; an amount of Iron (II, Oxide); an amount of copper; and an amount of carbon black.

In embodiments according to the present disclosure, the amount of graphite can be from about 20 wt % to about 55 wt %. In embodiments according to the present disclosure, the amount of aluminum oxide can range from about 5 wt % to about 15 wt %. In embodiments according to the present disclosure, the amount of iron (II, Oxide) can range from about 1 wt % to about 20 wt %. In embodiments according to the present disclosure, the amount of copper can range from about 1 wt % to about 30 wt %. In embodiments according to the present disclosure, the amount of carbon black can range from about 5 wt % to about 25 wt %. In embodiments according to the present disclosure, the amount of graphite can be about 34 wt %. In embodiments according to the present disclosure, the amount of aluminum oxide can be about 12 wt %. In embodiments according to the present disclosure, the amount of iron (II, III) oxide can be about 15 wt %. In embodiments according to the present disclosure, the amount of copper can be about 27 wt %. In embodiments according to the present disclosure, the amount of carbon black can be about 12 wt %. In embodiments according to the present disclosure, the amount of water that can be about 0 wt/v % to about 20 wt/v %.

In embodiments according to the present disclosure, a paint primer additive consists of: an amount of graphite; an amount of aluminum oxide; an amount of Iron (II, Oxide) an amount of copper; and an amount of carbon black. The amount of graphite ranges from about 20 percent to about 55 wt %. The amount of aluminum oxide ranges from about 5 wt % to about 15 wt %. The amount of iron (II, Oxide) ranges from about 1 wt % to about 20 wt %. The amount of copper ranges from about 1 wt % to about 30 wt %. The amount of carbon black ranges from about 10 wt % to about 25 wt %.

Described herein are embodiments of paint primer formulations. Embodiments of paint primer formulations as described herein comprise: an amount of a paint primer additive as described herein; and a base composition. The base composition can be a paint primer. The base composition can be a water-based paint primer.

Described herein are methods of using paint primer formulations as described herein. Methods of using paint primer formulations as described herein can comprise coating a surface or a portion thereof paint primer formulation as described herein. According to methods as described herein, the surface or portion thereof can be coated with 1 to about 6 coats of the paint primer formulation.

Described herein are methods of obstructing transmission of electromagnetic wavelengths through a surface, the method comprising coating a surface or a portion thereof with a paint formulation as described herein. Methods as described herein can further include providing electromagnetic waves having frequencies between about 2 and about 60 GHz. Methods as described herein can further providing a source of electromagnetic waves having frequencies between about 2 and about 60 GHz. The paint formulation of methods as described herein can be a composition comprising an effective amount of primer additive to lower an amount of electromagnetic wavelengths transmitted through the surface from a first level to a second level, wherein the first level is higher than the second level. The first level of methods as described herein can be about 3 V/m to about 5 V/m and the second level can be about 0.2 V/m to about 1 V/m.

The effective amount of primer additive according to compositions and methods as described herein can comprise one or more of: an amount of graphite ranging from about 20 percent to about 55 wt %; an amount of aluminum oxide ranging from about 5 wt % to about 15 wt %; an amount of iron (II, Oxide) ranging from about 1 wt % to about 20 wt %; an amount of copper ranging from about 1 wt % to about 30 wt %; and an amount of carbon black ranging from about 10 wt % to about 25 wt %.

In embodiments according to the present disclosure, the effective amount of primer additive according to compositions and methods as described herein consists of: an amount of graphite ranging from about 20 percent to about 55 wt %; an amount of aluminum oxide ranging from about 5 wt % to about 15 wt %; an amount of iron (II, Oxide) ranging from about 1 wt % to about 20 wt %; an amount of copper ranging from about 1 wt % to about 30 wt %; and an amount of carbon black ranging from about 10 wt % to about 25 wt %.

### BRIEF DESCRIPTION OF THE DRAWINGS

Further aspects of the present disclosure will be readily appreciated upon review of the detailed description of its various embodiments, described below, when taken in conjunction with the accompanying drawings.

FIGS. 1A and 1B illustrate aspects 100a and 100b of the present disclosure. FIG. 1A illustrates transmission of electromagnetic radiation through a surface 100a. As shown in FIG. 1A, electromagnetic radiation 103 from a source 101 is transmitted through a surface 105. FIG. 1B illustrates transmission of electromagnetic radiation through a surface 100b. As shown in FIG. 1A, there is a reduction in electromagnetic radiation 103 from a source 101 transmitted through a surface 105 upon coating the surface 105 with a coating 107 as described herein.

FIG. 2 is a flow chart illustrating an embodiment of a method according to the present disclosure. According to the method 200 in FIG. 2, a mixing container 201 is provided. Aluminum (III) oxide, iron (IV) oxide, and copper are added to the mixing container 203. Graphite and carbon black are then added to the mixing container 205, and the contents can be added slowly. The contents of the mixture can then be stirred together to form a homogenous mixture 207.

FIG. 3 is a flow chart illustrating an embodiment of a method according to the present disclosure. According to the method 300 in FIG. 3, a primer additive 301 is provided. A primer 303 is provided, and then added to the primer additive 305. The mixture is then stirred together to form a homogenous mixture 307.

FIG. 4 is a flow chart illustrating an embodiment of a method according to the present disclosure. According to the method 400 in FIG. 4, a primer additive/primer mixture is provided 401 and then a surface is coated with the primer additive/primer mixture 403.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

Where a range is expressed, a further aspect includes from the one particular value and/or to the other particular value. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, “about,” “approximately,” “substantially,” and the like, when used in connection with a numerical variable, can generally refers to the value of the variable and to all values of the variable that are within the experimental error (e.g., within the 95% confidence interval for the mean) or within +/−10% of the indicated value, whichever is greater. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Embodiments of the present disclosure will employ, unless otherwise indicated, techniques of chemistry, organic chemistry, biochemistry, physics, electrical engineered and the like, which are within the skill of the art. Such techniques are explained fully in the literature.

Discussion

It can be desirable to block one or more electromagnetic wavelength. While devices exist that can block electromagnetic wavelengths, some are bulky devices or are otherwise impractical and hard to adapt to large and/or complex surfaces. With that said, described herein are paint additive formulations that can be added to a paint composition, such as a primer, that can form a coating on a surface that can block one or more wavelengths of energy. Other compositions, compounds, methods, features, and advantages of the present disclosure will be or become apparent to one having ordinary skill in the art upon examination of the following drawings, detailed description, and examples. It is intended that all such additional compositions, compounds, methods, features, and advantages be included within this description, and be within the scope of the present disclosure.

Paint Additives and Paint Formulations Thereof

Described herein are paint additives and paint formulations thereof that can absorb or otherwise block transmission of electromagnetic wavelengths through a surface. Described herein are paint additives. The paint additives can be added to a paint primer to from a paint primer formulation. The paint additive can be a solid powder. The paint primer can be a semi-solid, paste, or liquid. The paint additive can include an amount of graphite, an amount of carbon black, an amount of aluminum oxide, an amount of iron oxide, and an amount of copper. The iron oxide can be iron (II, Oxide). All compounds that can be included in the additive can all be electrically conducting materials. This allows the paint primer formulation to which the paint additive has been added to obstruct one or more electromagnetic waves. Obstruction of one or more electromagnetic waves can be via absorption, reflection, and/or dispersion by the surface coated with a paint primer additive and/or formulation thereof.

The paint primer additive can include about 20 percent to about 55 percent (wt %) graphite (or about 25 percent to about 50 percent, or about 30 percent to about 45 percent, or about 35 percent to about 40 percent). The paint primer additive can include about 5 percent to about 15 percent (wt %) aluminum oxide (Al₂O₃)(or about 7.5 percent to about 12.5 percent or about 10%). The paint primer additive can include about 1 percent to about 20 percent (wt %) Iron (II, Oxide) (Fe₃O₄)(or about 2.5 percent to about 17.5 percent, or about 5 percent to about 15 percent, or about 7.5 percent to about 12.5 percent, or about 10 percent). The paint primer additive can include about 1 percent to about 30 percent (wt %) copper (Cu). The paint primer additive can include about 5 percent to about 25 percent (wt %) carbon black (or about 7.5 percent to about 22.5 percent, about 10 percent to about 20 percent, about 12.5 percent to about 17.5 percent, or about 15 percent). The paint primer additive can include about 0 to about 20 percent (w/v or wt %) water (or about 2.5 percent to about 17.5 percent, or about 5 percent to about 15 percent, or about 7.5 percent to about 12.5 percent, or about 10 percent). In some aspects, the paint primer additive can include about 34 percent (wt % or w/v) graphite, about 12 percent (wt % or w/v) aluminum oxide, about 15 percent (wt % or w/v) iron (II Oxide), and about 12 percent (wt % or w/v) carbon black. In some aspects, these are the only ingredients in the paint primer additive. Table 1 below shows various embodiments of the paint primer additive.

TABLE 1

| | Current | | |
|---|---|---|---|
| | Percentage | Range | Range |
| Material | (wt %) | (wt %) | Volume |
| Graphite | 34.0138% | 20%-55% | 30%-70% |
| Aluminum Oxide (Al₂O₃) | 11.8583% | 5%-15% | 5%-20% |
| Iron (II Oxide) (Fe₃O₄) | 15.5209% | 1%-20% | 1-15% |
| Copper (Cu) | 26.8988% | 1%-30% | 1-15% |
| Carbon Black | 11.7082% | 5%-25% | 5-35% |
| Water | 0.00% | 0%-20% | 0-40% |

The paint primer additive can be made by mixing the compounds using a mixing method and technique generally known in the art.

Also described herein are paint primer formulations (also referred to herein as the working paint primer formulation) that can include an amount of a paint primer additive described herein and a base composition. Thus, the paint primer additive described herein can be concentrated as compared to when it is included in the working paint primer formulation. The base composition can be a ready-made paint primer formulation commercially available at a store, such as a hardware or specialty paint store. The primer can be water-based. The primer can be oil-based. The base composition can be a paint primer. The base composition can include additional additives such as thinners, dyes, antimicrobial compounds, and the like, which are known in the art. Once added to the base composition, the paint primer additive can become diluted to a final working concentration in the base composition such that each of the compounds is diluted as compared to their form in the paint primer additive.

Table 2 provides exemplary amounts of each component of the paint primer additive that can be added to one gallon of a base composition (e.g. off-the-shelf primer).

TABLE 2

| | Approx. | Approx. | | Current | | Current | |
|---|---|---|---|---|---|---|---|
| | Volume | Volume | Approx. | Mass | Range | Percentage | Range |
| Component | (cups) | (gal) | Mass (g) | Percentage | Mass | volume | Volume |
| Graphite | 10.0000 | 0.6250 | 1072.2179 | 34.01% | 20%-55% | 50.00% | 30%-70% |
| Al₂O₃ | 2.0000 | 0.1250 | 373.8094 | 11.86% | 5%-15% | 10.00% | 5%-20% |
| Fe₃O₄ | 2.0000 | 0.1250 | 489.2645 | 15.52% | 1%-20% | 10.00% | 1%-15% |
| Cu | 2.0000 | 0.1250 | 847.9322 | 26.90% | 1%-30% | 10.00% | 1%-15% |
| Carbon | 4.0000 | 0.2500 | 369.0776 | 11.71% | 5%-25% | 20.00% | 5%-35% |
| Black | | | | | | | |
| Water | 0.0000 | 0.0000 | 0.0000 | 0.00% | 0%-20% | 0.00% | 0%-40% |

The paint primer additive when included in a paint primer formulation described herein can be effective to block, by absorbing, reflecting, and/or otherwise dispersing one or more electromagnetic waves. In some aspects, the frequency of the electromagnetic waves can that can be blocked by the working paint formulation can be super high frequencies (e.g. those frequencies between about 2 gHz and about 60 GHz, about 2 gHz to about 8 gHz, about 5 gHz to about 55 gHz, about 10 gHz to about 50 gHz, about 15 gHz to about 45 gHz, about 20 gHz to about 40 gHz, about 25 gHz to about 35 gHz, or about 30 gHz, or about 2.4 gHz). This can be about the frequency range a typical household WiFi router signal strengths. In some aspects, the blocked frequencies can lie more in the category of radio frequencies and microwave frequencies along the electromagnetic spectrum.

Methods of Using the Paint Additives and Paint Formulations Thereof

An amount of the paint primer additive can be added to an amount of a base composition to generate a working paint primer formulation. The working paint primer formulation can be coated on at least a portion of a surface of an object. The working paint formula can be effective to block (e.g. absorbing, reflecting or otherwise dispersing one or more electromagnetic waves) away from the surface that was coated. One or more coats can be applied to the one or more surfaces of an object. In some aspects, 1, 2, 3, 4, 5 or 6 coats are applied to a surface. Any surface can be coated with at least one coat of the working paint primer formulation on a portion of the surface. Exemplary surfaces that can be coated in at least a region with the working paint primer formulation described herein can include but are not limited to, wood, sheet rock, cement, plaster, and other materials used in the construction of residential and commercial buildings that are known in the art.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Example 1

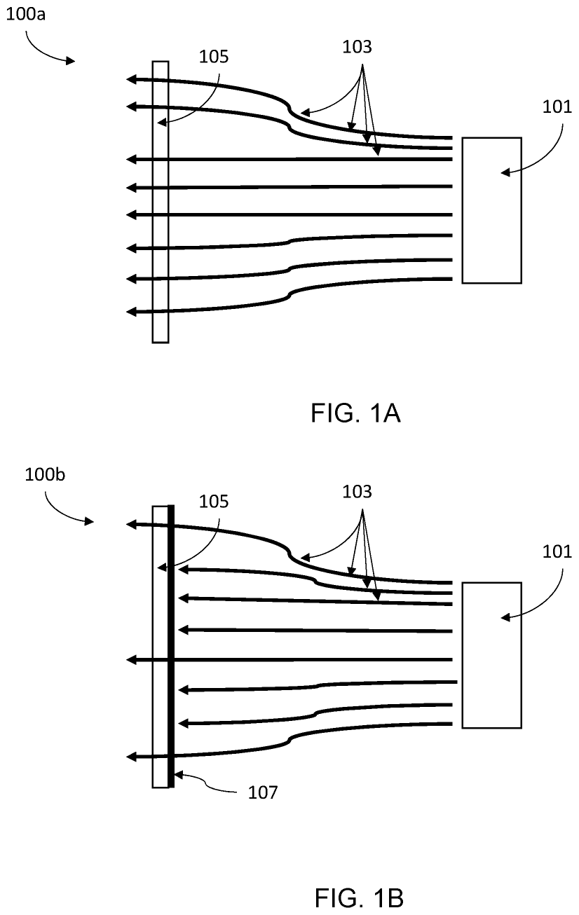

FIGS. 1A and 1B illustrate aspects 100a and 100b of the present disclosure. FIG. 1A illustrates transmission of electromagnetic radiation through a surface 100a. As shown in FIG. 1A, electromagnetic radiation 103 from a source 101 (such as a WiFi router) is transmitted through a surface 105. FIG. 1B illustrates transmission of electromagnetic radiation through a surface 100b. As shown in FIG. 1A, there is a reduction in electromagnetic radiation 103 from a source 101 transmitted through a surface 105 upon coating the surface 105 with a coating 107 as described herein. The surface can be a surface as described herein, and the illustration of the reduction in electromagnetic radiation 103 as illustrated in FIGS. 1A-1B is not intended to be quantitative.

### Example 2

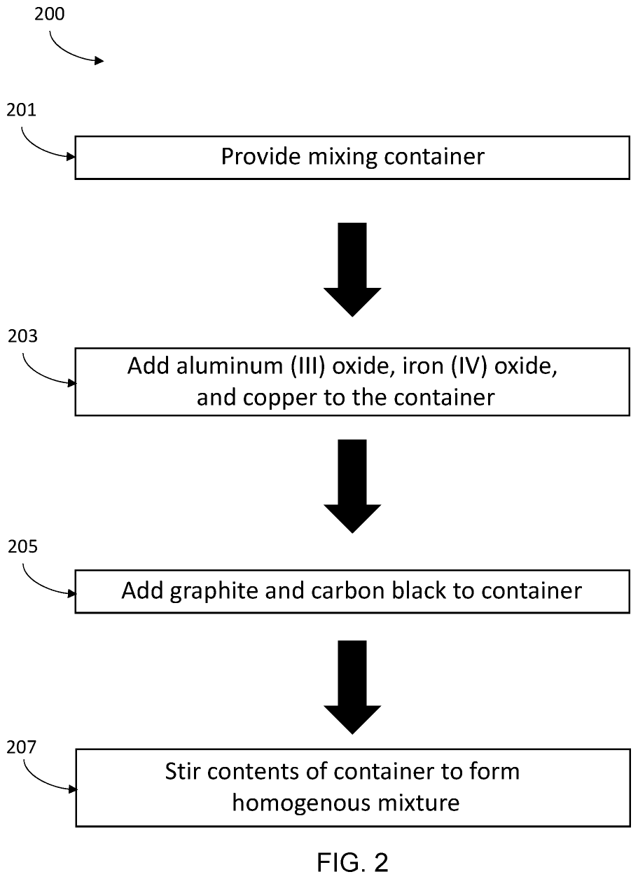

FIG. 2 is a flow chart illustrating an embodiment of a method according to the present disclosure. According to the method 200 in FIG. 2, a mixing container 201 is provided. Aluminum (III) oxide, iron (IV) oxide, and copper are added to the mixing container 203. Graphite and carbon black are then added to the mixing container 205, and the contents can be added slowly. The contents of the mixture can then be stirred together to form a homogenous mixture 207. As one of skill in the art would understand, the exact order of the mixing can be altered and varied according to the desires of the skilled artisan.

### Example 3

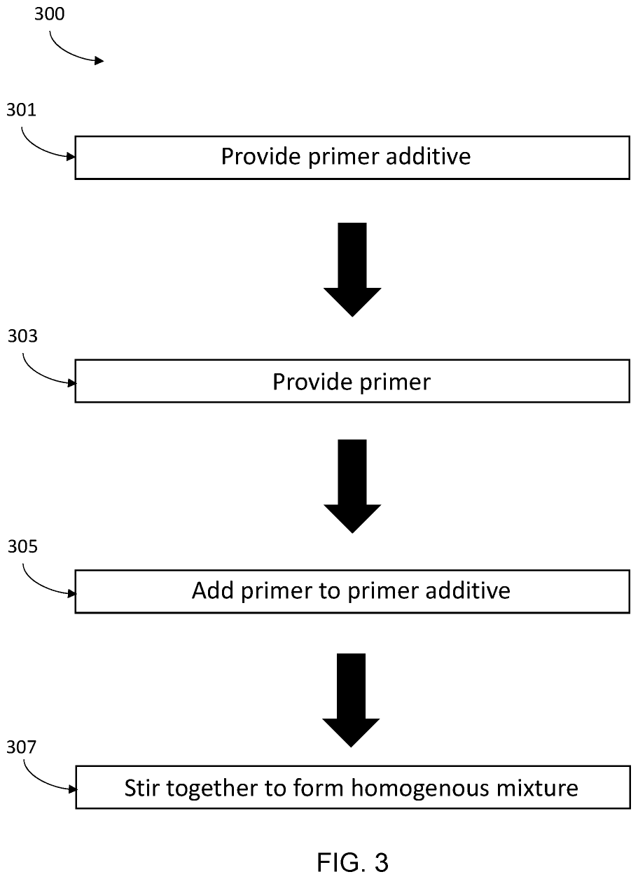

FIG. 3 is a flow chart illustrating an embodiment of a method according to the present disclosure. According to the method 300 in FIG. 3, a primer additive 301 is provided. A primer 303 is provided, and then added to the primer additive 305. The mixture is then stirred together to form a homogenous mixture 307. Following stirring, optionally, water can be added to the mixture and the mixture diluted accordingly.

### Example 4

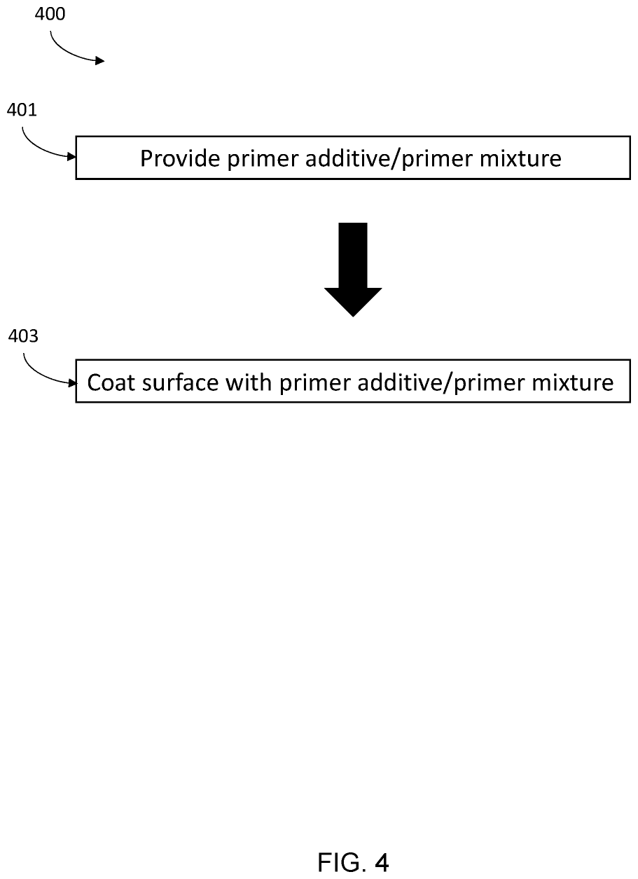

FIG. 4 is a flow chart illustrating an embodiment of a method according to the present disclosure. According to the method 400 in FIG. 4, a primer additive/primer mixture is provided 401 and then a surface is coated with the primer additive/primer mixture 403.

### Example 5

Described in the present example is a WiFi-blocking additive composition for primer. An aspect of the present example includes creating a sufficient amount of additive (1.25 gallons) to put into (or mix with) 1 gallon of water-based primer.

The following materials were obtained for the WiFi-blocking additive composition:
0.625 gallons of powdered graphite (approx. 1072.22 grams)
0.125 gallons of powdered aluminum (III) oxide (approx. 373.81 grams)
0.125 gallons of powdered iron (IV) oxide (approx. 489.26 grams)
0.125 gallons of powdered copper (approx. 847.93 grams)
0.125 gallons of powdered carbon black (approx. 369.08 grams)
0.4 gallons of water
ACE Hardware® water-based paint primer

The primer was a water-based primer so that the primer/additive mixture could later be diluted by water to reduce its viscosity. The primer was a general water-based primer from ACE Hardware® 1 gallon in volume.

Without intending to be limiting, an embodiment of a method of preparing the primer additive is as follows, although the skilled artisan would understand other methods of preparing the mixture:
1. A 5-gallon paint bucket in which the mixture could be prepared was acquired.
2. The materials above were then deposited into the 5-gallon paint bucket. The order in which all the materials were added did not matter because they were ultimately to be mixed into a homogenous mixture. However, the materials can be added in a certain order (as follows) to prevent loss of material when entering the bucket. The first materials added were the aluminum (III) oxide, iron (IV) oxide, and copper. The order in which these three materials were added did not matter. These three materials were added first because they were the densest of all the materials that comprised the additive.
3. The graphite and carbon black was then deposited into the 5-gallon bucket containing the mixture above. These materials had a lower density, so if they were quickly deposited into the bucket some of the powder could float out of the bucket while the rest settled. Thus, the graphite and carbon was added black slowly so that the materials could settle as poured, and after all the graphite and carbon black was put into the bucket the lid was put over the bucket to prevent any additional material loss while the materials settled. If the denser metals had been added after the graphite and carbon black, they would have sunk through the graphite and carbon black and possibly caused some of the graphite and carbon black to fly up through the opening of the top of the bucket.
4. After all the material was in the 5-gallon bucket, a wooden stick was used to stir the mixture to form a homogenous mixture so that the materials would be more evenly distributed. This stirring was conducted for around 5 minutes, although other stir times may be suitable. The denser materials would still be at the bottom of the mixture, but with the stirring the distribution of materials would be more even.

### Creating the Additive/Primer Mixture

After the additive was prepared above according to steps 1-4, it was then added to the water-based ACE Hardware® primer.
5. Using the same 5-gallon mixing bucket with the additive already inside, the 1 gallon of ACE Hardware® water-based primer was poured in. After the entire 1 gallon of water-based primer was poured in, wooden stirring sticks were used to stir the additive/primer mixture for about 10 minutes. An objective of stirring was to stir the additive/primer mixture until the 5-gallon bucket contained a homogenous mixture with the additive evenly distributed throughout the primer.
6. The resulting additive/primer mixture was very viscous. Because the additive/primer mixture would later be applied on the wall, about 0.4 gallons (1.5 liters) of water was added into the additive/primer mixture. The mixture was then again stirred with the wooden stirring sticks for 10 minutes, so that the water was combined with the water-based primer to create a homogenous mixture. If the primer used was not water-based, the water would have not mixed with the additive/primer mixture.

### Application and Testing of the Additive/Primer Mixture

7. A house was found near downtown Atlanta, which was identified as a suitable test site as that was where we would have the highest concentration of the harmful microwave-level radiation.
8. The level of ambient radiation in the area was measured using an EMFields Acoustimeter. The initial reading (average of three trials/readings) fluctuated between about 3 V/m to about 5 V/m.
9. The additive/primer mixture from steps 1-6 above was then provided.
10. Using the mixture from steps 1-6 above, a room in the house was painted, which was mid-size (around 8×6 feet).
   The room was again tested after painting with the same EM Fields Acoustimeter. Following application of the additive/primer mixture, it was found that the reading fluctuated between about 0.2 V/m to about 1 V/m (average result of three trials/readings). This demonstrates that the application of the created the additive/primer mixture lowered the amount of radiation entering the room, but it did not reduce amount to 0 V/m. This is significant as it can block radiation, such as WiFi signals while still allowing for the use of devices such as baby-monitors.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

We claim:

1. A primer paint additive comprising:
an amount of graphite;
an amount of aluminum oxide;
an amount of Iron (II, Oxide)
an amount of copper; and
an amount of carbon black.

2. The paint primer additive of claim 1, wherein the amount of graphite ranges from about 20 wt % to about 55 wt %.

3. The paint primer additive of claim 1, wherein the amount of aluminum oxide ranges from about 5 wt % to about 15 wt %.

4. The paint primer additive of claim 1, wherein the amount of iron (II, Oxide) ranges from about 1 wt % to about 20 wt %.

5. The paint primer additive of claim 1, wherein the amount of copper ranges from about 1 wt % to about 30 wt %.

6. The paint primer additive of claim 1, wherein the amount of carbon black ranges from about 5 wt % to about 25 wt %.

7. The paint primer additive of claim 1, wherein the amount of graphite is about 34 wt %.

8. The paint primer additive of claim 1, wherein the amount of aluminum oxide is about 12 wt %.

9. The paint primer additive of claim 1, wherein the amount of iron (II, III) oxide is about 15 wt %.

10. The paint primer additive of claim 1, wherein the amount of copper is about 27 wt %.

11. The paint primer additive of claim 1, wherein the amount of carbon black is about 12 wt %.

12. The paint primer additive of claim 1, further comprising an amount of water that is about 0 wt/v % to about 20 wt/v %.

13. A paint primer formulation comprising:
an amount of a paint primer additive of claim 1; and
a base composition.

14. The paint formulation of claim 13, wherein the base composition is a paint primer.

15. A method comprising:
coating a surface or a portion thereof paint primer formulation of claim 13.

16. The method of claim 15, wherein the surface or portion thereof is coated with 1-6 coats of the paint primer formulation.

17. A method comprising:
obstructing transmission of electromagnetic wavelengths through a surface, the method comprising coating a surface or a portion thereof with a paint formulation of claim 13.

18. The method of claim 17, wherein the paint formulation is a composition comprising an effective amount of primer additive to lower an amount of electromagnetic wavelengths transmitted through the surface from a first level to a second level, wherein the first level is higher than the second level.

19. The method of claim 18, wherein the first level is about 3 V/m to about 5 V/m and the second level is about 0.2 V/m to about 1 V/m.

20. The method of claim 18, wherein the effective amount of primer additive comprises one or more of:
an amount of graphite ranging from about 20 percent to about 55 wt %;
an amount of aluminum oxide ranging from about 5 wt % to about 15 wt %;
an amount of iron (II, Oxide) ranging from about 1 wt % to about 20 wt %;
an amount of copper ranging from about 1 wt % to about 30 wt %; and
an amount of carbon black ranging from about 10 wt % to about 25 wt %.
